(19) United States
(12) Patent Application Publication
(10) Pub. No.: US 2019/0254262 A1
(43) Pub. Date: Aug. 22, 2019

(54) Method, System and Apparatus for Corner Seam Reinforcing Brace

(71) Applicant: Gaston Bianchi, Hialeah, FL (US)

(72) Inventor: Gaston Bianchi, Hialeah, FL (US)

(21) Appl. No.: 16/249,102

(22) Filed: Jan. 16, 2019

Related U.S. Application Data
(60) Provisional application No. 62/709,435, filed on Jan. 19, 2018.

(51) Int. Cl. A01K 63/00; B31B 50/81; A01K 1/00

(52) U.S. Cl. CPC A01K 63/006; B31B 50/8121; A01K 63/04; A01K 1/0047; B31B 50/813

(57) ABSTRACT

Method, System and Apparatus of a Corner Seam Reinforcing Brace.

### CROSS-REFERENCE TO RELATED APPLICATIONS

Claiming Priority to US 62/709,435

### SEQUENCE LISTING OR PROGRAM

Not Applicable

### BACKGROUND

### Field

This application relates to Corner Seam Reinforcing Braces.

### SUMMARY

This information summary relates to a product modification called “CORNER SEAM REINFORCING BRACE” which is been disclose to USPTO by Mr. Gaston D. Bianchi of Hialeah Fla. The result is a reference tool which can be used to submit “CORNER SEAM REINFORCING BRACE” to the industry in a logical format which stresses it positive and most appealing features.

Description: Product Concept Review

In this information summary, we will review the distinctive features of the product and the needs it might fulfill. The concept of “CORNER SEAM REINFORCING BRACE” is an improved aquarium internal design. As with conventional units, it can be produced at any dimension and thickness, in both glass and acrylic versions. For its unique simplicity and safe operation, it should be assembled on all four internal vertical corners of any aquarium, starting from the bottom all the way to the top or around the bottom and top perimeters, either on a new or an used glass or acrylic aquarium to improve its structure strength or to shield the internal joint seams from being damaged by sharp objects or other creatures living in the aquarium.

Function and appealing features:
Statistics: As any conventional aquarium, it's lifetime can be greatly extended when adding Corner Seams Reinforcing Braces to all vertical corners and or to top/bottom perimeter.
Add structure strength to any type of aquarium.
Guard and protect joint seams from being damaged by sharp objects, magnets cleaners or living creatures.
Helps to divert water to revolve and flow freely without being blocked at a 90% corner angle.
Slick feel and modern look.

Historical Development:

I Gaston D. Bianchi identified a need or a problem to be solved, that prompted me into the invention process. Then I conceived “CORNER SEAM REINFORCING BRACES” and created a prototype, because of its visibility and tangibility, makes easier for anyone who may become interested in the idea or to have a clearer understanding of its concept and purpose. Subsequently, sketches, drawing, pictures and a written description were prepared for review.

### DRAWINGS—FIGURES

The Method, System and Apparatus of a Corner Seam Reinforcing Brace is described in the following drawings which are described briefly as follows:

FIG. 1: Set of four strips of glass triangular shaded 48″ inches long by 1″ inch wide. 48″ corner seam reinforcing braces, clear glass 1″ wide;

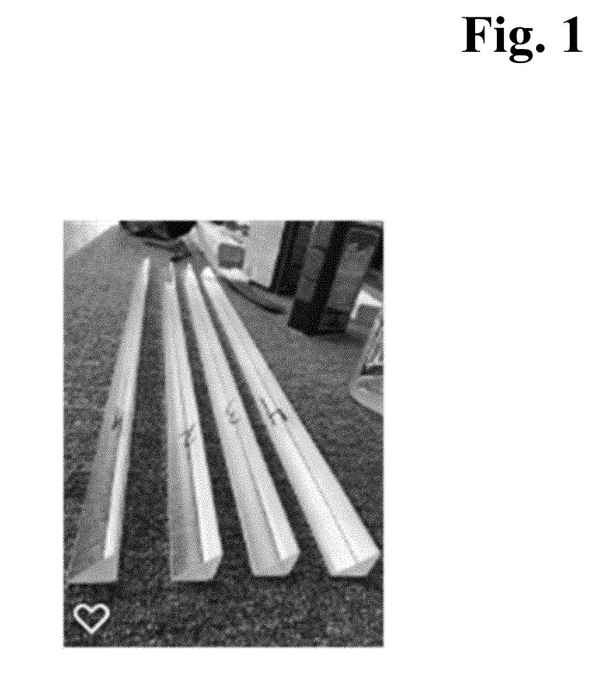

FIG. 2: View from above of placement prior to assembly; corner seam brace prior to assembly 24″ L×¾″ W; Glass aquarium internal vertical 90 degrees corner;

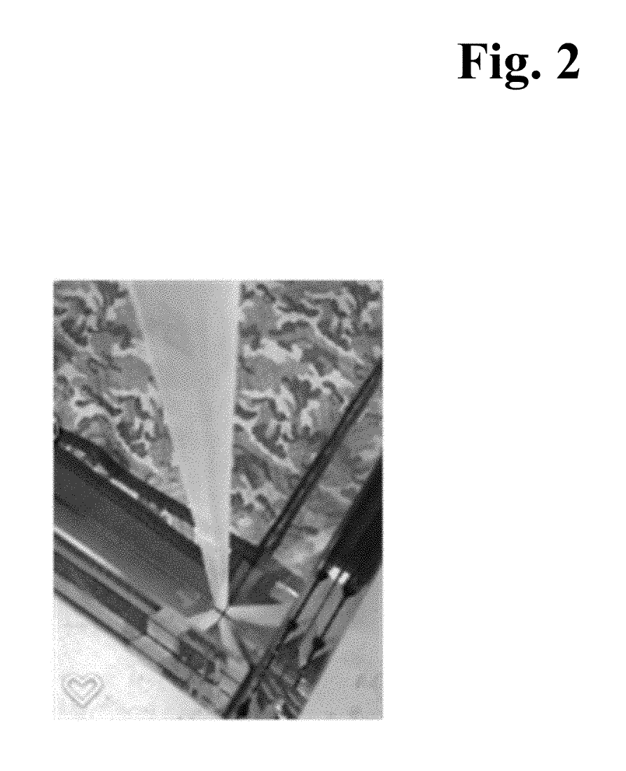

FIG. 3: View from above of placement prior to cutting to size; corner seam brace prior to assembly ¾″ wide; Glass aquarium internal vertical 90 degrees corner;

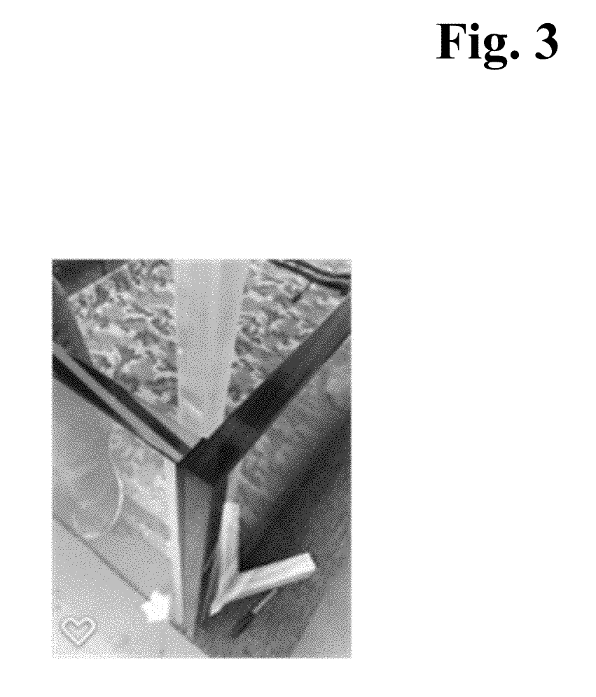

FIG. 4: Above view fully assembled; corner seam brace fully assembled 18″ L×1″ W; Glass aquarium internal vertical corner;

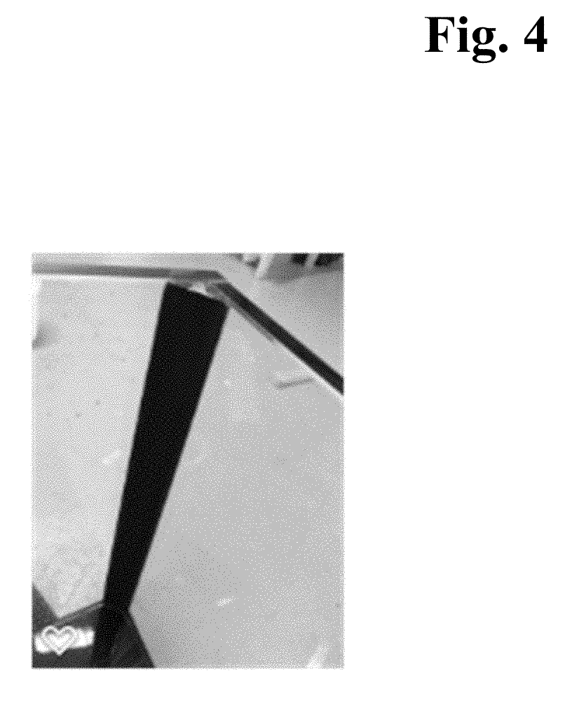

FIG. 5: Inside view fully assembled; corner seam reinforcing brace viewed from the inside after assembling 12″ L×1″ W;

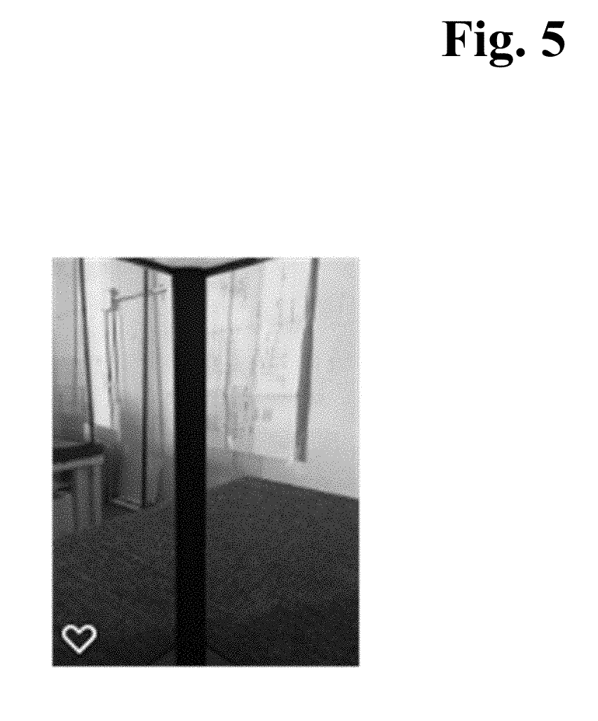

FIG. 6: Set of four corner seam reinforcing braces fully assembled 18″ L×1″ W;

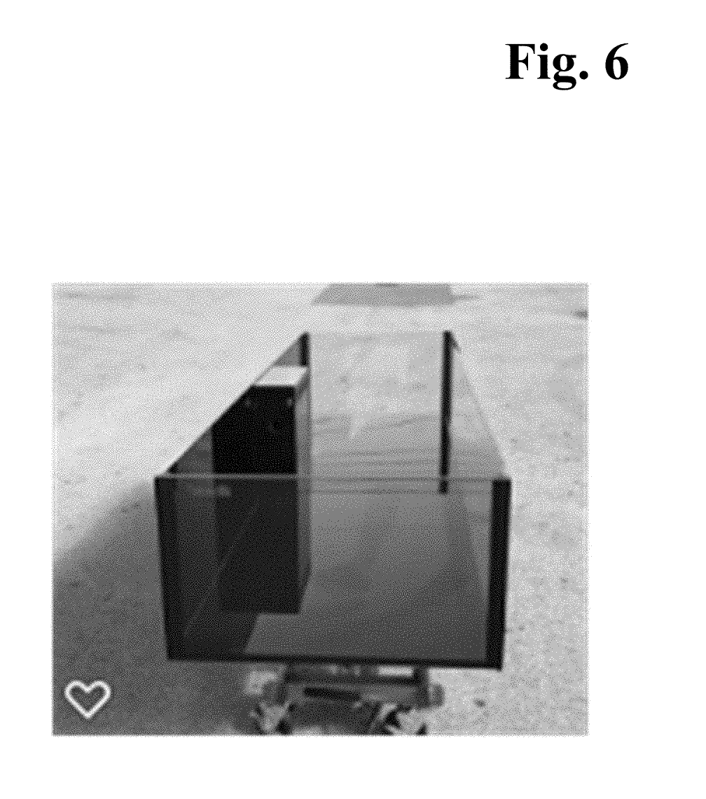

FIG. 7: Inside view fully assembled; corner seam reinforcing brace viewed from the inside after assembling 24″ L×¾″ W;

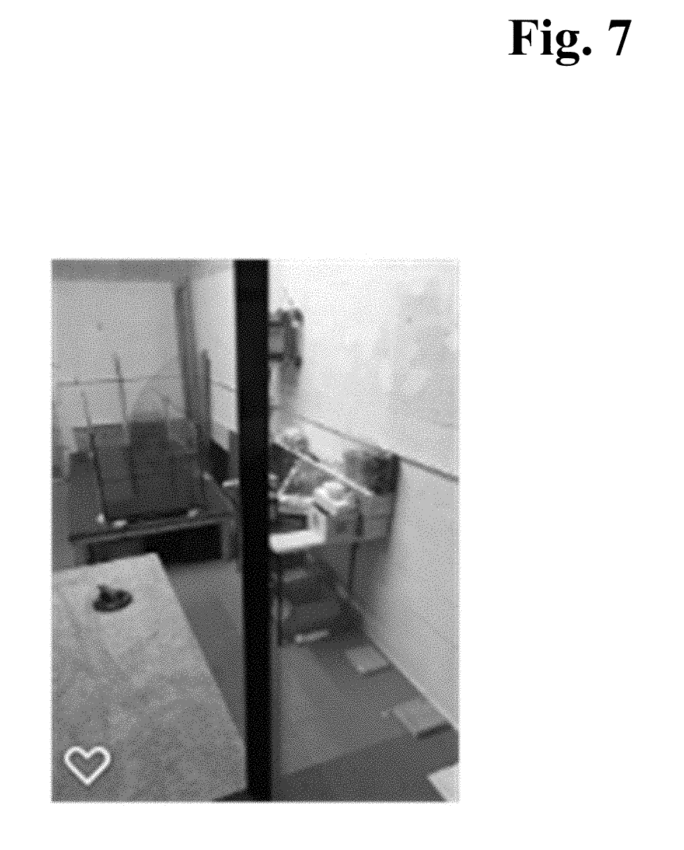

FIG. 8: Inside view corner seam reinforcing braces fully assembled; corner seam reinforcing brace 30″L×1″ W.

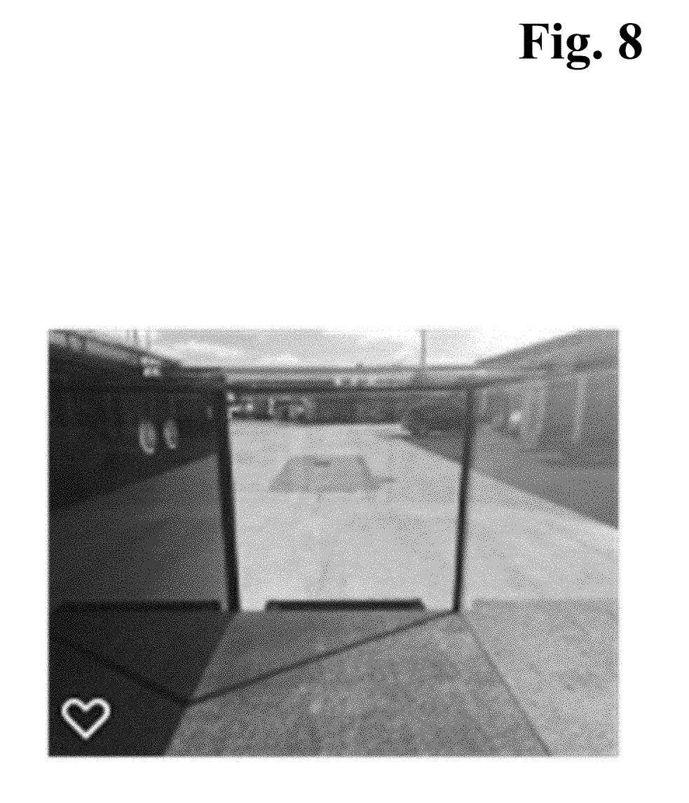

I claim:

1-Corner Seams Reinforcing Braces provide a much stronger aquarium integrity;

2-The method in claim 1, and further providing improved water performance revolving within the corners;

3-The method in claim 1, and absolute protection of the silicone seams;

4-The method in claim 1, and no obstruction of the aquarium habitat.
